(19) United States
(12) Patent Application Publication
(10) Pub. No.: US 2024/0016107 A1
(43) Pub. Date: Jan. 18, 2024

(54) Method for Operating a Culture Facility for Aquatic Plants, and Culture Facility Itself, and Computer Program Product

(71) Applicant: Uniper Kraftwerke GmbH, Düsseldorf (DE)

(72) Inventor: Karl-Michael SCHMIDT, Moers (DE)

(73) Assignee: Uniper Kraftwerke GmbH, Düsseldorf (DE)

(21) Appl. No.: 18/256,881

(22) PCT Filed: Dec. 13, 2021
(86) PCT No.: PCT/EP2021/085464

§ 371 Date: Jun. 9, 2023

(30) Foreign Application Priority Data
Dec. 11, 2020 (DE) 102020133132.0

(51) Int. Cl. A01G 31/06

(52) U.S. Cl. CPC A01G 31/06

(57) ABSTRACT

The invention relates to a method for operating a culture facility for aquatic plants, and to a culture facility itself, in which aquatic plants, especially duckweeds, are employed, according to the preamble to claims 1 and 31, and also to a computer program product according to claims 32 and 33. The culture is populated by seeding with aquatic plants initially along a growth sigmoid to a coverage state of more than 50% above the species- and light-dependent coverage limit ascertained beforehand. Thereafter, an amount of 5/−70% of the respective coverage is harvested at cyclically recurring intervals of time, referred to as harvest cycle times. Modelling of the growth process is used to predeterminedly optimize the culture parameters of temperature, carbon dioxide and light and these are then fed into the controller of a harvesting unit or harvesting process as control variables for optimally triggering a harvest time. Harvest time and/or harvest amplitude are automatically readjusted in the event of fluctuating temperatures and/or illumination values and/or carbon dioxide concentrations within the culture facility.

The present invention relates to a method for operating a culture facility for aquatic plants, and the culture facility itself, where aquatic plants, in particular duckweed (Lemnaceae), are used, and a computer program product.

The use of the method according to the application is suitable for all genera (species) of Lemnaceae: These are: Lemna, Spirodela, Wolffia, Wolfiella, Landolthia, and possible crosses between the genera.

### STATE OF THE ART

The general cultivation of duckweed for the production of animal feed using an indoor method is known, inter alia, from the documents EP 2 331 238 B1 and EP 2 928 286 B1.

Duckweed is known to be low light tolerant. Thus, it is suitable for indoor cultivation in a greenhouse. On the other hand, it can be cultivated in a stacked culture tray system. At least, sprouting is possible in the vegetative propagation zone under low light conditions. It has further been shown that appropriate auxiliary lighting for certain zones is possible using modern, wavelength-specific LED lights. It is also known from the documents mentioned above that duckweed can be cultivated in a tiered construction in order to generate a significantly higher base area yield for photo-bioreactors. Namely, this base area yield is multiplied by the number of tiers used on which the culture trays are arranged.

It is further known to divide a photo-bioreactor into zones. Various aquatic plant cultures can be cultivated in the zones in order to subsequently produce compound animal feed. However, the procedures and requirements for the production of a compound animal feed from aquatic biomass are clearly different from the requirements for the production of protein-maximized biomass or a highly pure protein or amino acid isolate.

The preparation of protein isolates from plant substrates is known as such. Biomasses, mostly land plants, are also harvested in the known methods. However, isolate production can never be better than what the raw material provides after harvest.

It is further known that duckweed has a tendency to hyperaccumulate metal ions, including heavy metal ions. These can be reduced already by the indoor method described by reducing environmental influences, such as those associated with outdoor cultivation. Depending on the water quality, however, appropriate measures must also be taken here, since even if, for example, condensation water is returned, it can have additional contact with metal and other surfaces on the way to the return.

### OBJECT OF THE INVENTION

The invention is therefore based on the object of further developing a culture method, a culture facility (=apparatus) and a computer program product of the generic type such that a high-quality resulting biomass and protein quality is achieved in the indoor method, with simultaneous determination and control of optimal culture conditions.

### SOLUTION

The stated object is achieved in a method of the generic type according to the invention by the characterizing features of claim 1.

In this regard, advantageous embodiments of the method are specified in the dependent claims 2 to 26.

With regard to a culture facility of the generic type, the stated object is achieved according to the invention by the characterizing features of claim 27.

In this regard, advantageous embodiments of the culture facility are specified in the dependent claims 28 to 31.

With regard to a computer program product, the stated object is achieved according to the invention by the features of claims 32 and 33.

The generic method serves for operating a culture facility for aquatic plants, wherein the aquatic plants are cultivated in a stacked culture tray system with an aquatic production area, wherein the aquatic plants are extracted by a cyclic and partial harvesting of the aquatic production area, wherein the aquatic plants grow back again on the aquatic production area until the following harvest. The method according to the invention expands the state of the art by the measures according to the invention that the culture is initially populated by seeding with aquatic plants along a sigmoidal growth curve to a coverage status of more than 50% above the previously determined variety- and light-dependent marginal coverage—here, population is referred to as the totality of aquatic plants occurring in a zone or tier or the culture tray system, that after populating to more than 50% marginal coverage at cyclically recurring time intervals, which are designated as harvesting cycle times, a quantity of 5%-70% of the respective coverage is harvested, that the harvesting cycle times are optimized in a predetermined manner via modelling the growth process with a temperature, a carbon dioxide (CO₂) concentration and/or a light supplied to the aquatic plants as culture parameters and fed in a controller of a harvesting apparatus or a harvesting method as a respective control variable for a determination of an optimal time for triggering a harvest. In the case of a change of one or more of these culture parameters within the culture facility, the respective time of the harvest and/or a respective harvesting amplitude are automatically readjusted. Harvesting amplitude means the quantity of harvest extracted from the culture at each harvest.

In the following, the sigmoidal growth curve is also called growth or population sigmoid or sigmoid for short. This can genus- and variety-dependent. This sigmoidal growth curve as well as the plant- and/or variety-specific parameters (culture parameters) for light, additional Co₂ supply, nutrition (fertilization) and temperature have been determined for the aquatic plant varieties used before the culture facility is operated and have been stored in an adaptive data field in the controller, for example, in a memory region of the controller. The sigmoidal growth curve is modelled on this basis, wherein the harvesting cycle times and/or the coverage status correspond to a (precisely predetermined) sawtooth curve progression.

For this purpose, a further embodiment according to the invention is that a sigmoidal growth curve, which can be genus- and variety-dependent, is beforehand determined for the aquatic plant varieties used and stored in an adaptive data field, from which the sigmoid determined on this basis is then modelled as growth curve by the harvesting cycles or the coverage status running on an exactly predetermined sawtooth curve, and wherein values for the harvesting times from the thus automatically triggered modelling are automatically adapted in situ along the upper peak values of a resulting sawtooth curve of the coverage status on the culture and are supplied to the controller of a harvesting apparatus, which is then automatically triggered for harvesting. The correct (=optimal) harvesting time is therefore calculated by means of the modelling. This means that the modelling prepares the sigmoidal growth curve (or the sigmoid). The harvesting amplitudes are determined from this curve. This means that the sigmoid is converted into a continuous sawtooth curve and the region of regrowth is lined up with a parallel offset. Harvesting time and harvesting amplitude (harvesting quantity) can vary. The control of the harvesting apparatus or the harvesting method intervenes when a variation is detected and follows the growth behaviour of the culture.

With this method, it is possible for the first time to control the indoor method so that an adaptation of an automatic start of the harvest with respect to the harvesting times and harvesting cycles or the harvesting quantity and a likewise automatic adaptation to a yield-optimized cyclic biomass harvest is possible. If, for example, the temperature as a culture parameter permanently falls or rises over a pre-definable and adjustable time interval and/or the CO₂ concentration as a culture parameter falls or rises and/or the light supplied changes, an adaptation of the optimal harvesting time is automatically determined and, if necessary, the harvesting cycle times and/or harvesting quantity are automatically adapted. In this way, the culture tray system is always automatically operated at its optimum. After the culture has been extracted, the culture relaxes in density and expands again from the remaining culture region into the harvested region.

In a further embodiment of the invention, it is specified that the sigmoid is generated on the basis of a growth equation for limited growth, where a growth factor ri is formed in the exponent of a natural exponential function (e-function) as a product of a light-dependent, a temperature-dependent, a CO₂-dependent and a nutrient-dependent term, which is then stored in the controller of the harvesting quantity extracted for each harvest, via which the optimal harvesting times are then determined.

The growth equation is

$$W ( t ) = \frac{Wmax}{2} * ( tanhyp ( \frac{ri 0}{2} * ( {\prod }_{T , E , N , P , CO 2} ri ( j ) ) * t + \frac{Wmax}{2} ) + 1 )$$

and is a hyperbolic tangent function with:
Wmax=maximum possible coverage (variety- and lighting-dependent),
ri₀=base growth rate, and
Π_{T,E,N,P,CO2}^{ri(j))}=product of the individual growth coefficients for the culture parameters light, temperature, CO₂ (carbon dioxide concentration) and nutrients.

The growth coefficients for temperature α(ri(T)), input light β(ri(E)), nutrition γ(ri(N, P)), and CO₂ concentration δ(ri(CO₂)) are formulated as a product rule. The coefficients α, β, γ, δ result in values less than or equal to 1 (≤1), preferably, they are less than 1 but close to 1.

ri=ri0*|α(ri(T))|*|β(ri(E))|*|γ(ri(N,P))|*|δ(ri(CO₂))|

The overall result is a value less than or equal to 1, multiplied by the basic growth rate ri0, from which the effectively usable/achievable growth rate ri follows.

The growth coefficient with regard to nutrition is formed from the well-known Michaelis-Menten equation. The growth coefficients for the supplied light, the CO₂ concentration and the temperature are partly linear and are used from results determined form planting experiments.

If all the parameters light, CO₂, temperature, and nutrients are at the optimum, then this resulting growth factor in front of the basic growth rate ri₀ is 1. At the optimum of all parameters, the above-mentioned product equation is also equal to 1. It is essential to the invention that the culture facility is also then predictably controllable if the culture parameters are not at the optimum. According to the invention, optimal harvesting times and harvesting amplitudes are also calculated for this case and the culture facility or the harvesting apparatus is optimally controlled.

Corresponding starting values originate from a previously determined and then adaptively tracked data field. These values can be adapted with ongoing cultivation and harvesting operations. The system maximizes itself if temperature, CO₂, nutrients and light have been previously successively controlled to the optimum.

An in situ detection of the components of the biomass harvested (through the cyclic and partial harvesting of the aquatic production area) enables a determination of accumulated heavy metals and accumulated calcium oxalate. In order to minimize these heavy metal and calcium oxalate concentration values in a biomass to be harvested, the harvesting cycle times are adjusted via the modelling in such a way that temporally short harvesting cycles of 0.5 to 5 days result.

These are then adjusted in relation to the quantity of biomass removed in such a way that the total residence times of the aquatic plants on the aquatic production area are optimally shortened (=minimized) just as long as is necessary to build up the maximum protein content. It is important here that maximum protein levels are achieved in young aquatic plants, especially in duckweed (Lemnaceae).

Due to this method control, in which the harvesting cycle times and thus the residence times are optimally shortened, it is thus achieved cumulatively and according to the invention that the accumulation time for heavy metals and calcium oxalate is significantly reduced with a simultaneously high protein content.

With the invention, this cumulative effect has been achieved technically through the measures of the method control.

In order to support such a rapid propagation of biomass, it is also proposed that the nutrient solution later supplied into the culture apparatus in the method is balanced exactly in such a way that a later supplied quantity of nutrients in all macro-, oligo- and micronutrients is adjusted in such a way that it corresponds exactly to the respective consumption in the culture system along the harvesting cycle times (Δt). This is done under the further cumulative condition that simultaneously the nutrient level of nitrogen is preferably at 1+/−0.2 mmol/L culture liquid. Culture control that is adapted to daily consumption also effectively suppresses the unwanted, competitive algal co-population.

Starting from this nitrogen level, the remaining macro elements N, P, K and the oligo-element Mg (nitrogen N, phosphorus P, potassium K, magnesium Mg) are then adjusted in a molar ratio of

3/1≥N/P≥10/1

2/1≥N/K≥4/1

10/1≥mg≥5/1.

Adjusting these nutrient ratios solves another problem, namely that of suppressing algal co-population. Suppression of the algal co-population also maximizes the biomass yield of the desired aquatic plant, such as Lemnaceae.

This requires two cumulative measures. Compliance with the “molar” nutrient ratios mentioned above, as well as a controlled later supply of the nutrients several times a day at a small absolute level, which must correspond as closely as possible to the current consumption of the culture. On the one hand, this means that there is no accumulation of nutrients in the culture and, on the other hand, that algae growth is suppressed. An accompanying algal population reduces the harvesting quantity of duckweed. If the nutrient level is at a low level, adapted to the consumption of Lemna, the pH of the nutrient solution is more stable, around the value 6.0 to 7.0. In this range, the duckweed (Lemnaceae) overpopulates the alga.

In a further advantageous embodiment, it is specified that the sigmoid is generated on the basis of a growth equation for limited growth, in which a growth factor ri is formed in the exponent of an E function as the product of a light-dependent, a temperature-dependent, a CO₂-dependent and a nutrient-dependent coefficients, multiplied by a base growth rate (ri₀), which is then stored in the controller of the harvesting quantity extracted for each harvest, via which the optimal harvesting times are then determined via the control equation.

In this way, the system can be fully controlled automatically in relation to the harvesting quantity and quality of the harvesting mass.

In a further advantageous embodiment it is specified that the protein content in the culture is further adjusted by taking random samples and adapting them thereafter as coefficients of the control equation. The system can not only be moved to the optimum, but can also be influenced, for example, regarding protein quality according to desired requirements.

It is also specified that both low light zones and high light zones are integrally integrated in each culture tray of the culture tray system. Supplied light means a quantity of light or quantity of lighting or lighting of the aquatic plants. The supplied light is preferably related to “μmol/m²s”, i.e., a quantum mechanical photon flux density. The specification “μmol/m²s PAR (Photosynthetic Active Radiation) is to be understood as follows: μmol refers to an actual (countable) number of photons; m² is the illuminated area (to which the light is supplied) and s are seconds. The photon flux density given in this way can be well defined by controlling the harvesting apparatus because, for example, a number X of photons generate an ADP-ATP conversion. In this way, the maximum biomass synthesis that can be generated with the available photon flux density in the irradiated culture is calculated, the background to this is the quantum mechanical treatment of photosynthesis. For example, the high light zone in the lighting value is >40 μmols⁻¹m⁻² (=μmol/m²s) and the high light zone is either positioned within or in front of the partial harvesting zone. Only individual spectral line intensities can be specified in other units, for example in mW/m².

In this manner according to the invention, the harvesting quantity is thus adapted to the protein optimization process by its in situ adaptation. Both the nutrition of the aquatic cultures and the operation of additional lighting (as a control variable) are adapted in such a way that predeterminable amino acid spectra in the harvested biomass are generated.

The various lighting zones, in which preferably both global radiation and artificial light can be present together, are preferably present within one or within each culture tray in such a way that both low light zones and high light zones can result in each culture tray.

Both low light zones, which are used for pure propagation of a high number of individuals by sprouting, and the corresponding high light zones for mass and protein maturation, are preferably integrated within the same elongated culture tray.

This means that low light zones and high light zones are preferably no longer integrated into different culture trays (of the same culture tray system) with different light quality and light quantity but are integrated together within each elongated culture tray. This is done in such a way that at one end of the culture tray, e.g., with a length extension of 33% of the total length, the culture is locally exposed to high light, e.g., with an auxiliary LED artificial light lighting in PAR wavelength ranges (PAR wavelengths are those for photosynthesis relevant wavelengths at approx. 350 nm and 680 to 700 nm). However, the high light lighting of a low light tolerant plant is already at 80-100 μmols⁻¹m⁻², which is already pronounced low light for many other plants. However, in order to achieve optimal growth and to achieve a light-related limitation of fronds that are already partially pushing over one another, lighting in the LED artificial light zone of 125-160 μmols⁻¹m⁻² proves to be advantageous.

The remainder, e.g., 67%, of the length of the respective culture tray or trays is illuminated in the stacked arrangement either only with global radiation or with lower lighting (=supplied light) than in the high light zones.

Here, the invention makes use of the knowledge that the nitrogen uptake is dependent on the quantity of light available. However, with reference to the pronounced low light tolerance of Lemnaceae (duckweed), this means that the photosynthesis efficiency in Lemnaceae is, or must be, high.

The integration of high light zones and low light zones in one and the same respective culture tray follows from the surprising effect, which has been confirmed several times by measurements, that when the Lemnaceae are transferred from a culture tray exposed to low light to a separate culture tray exposed to high light by floating or the like, even small differences in the nutrient solution concentration and/or in the conductivity and/or the pH value are sufficient to inhibit further propagation of the Lemnaceae for up to 72 hours. For this reason, it has been shown that it is advantageous that remaining in the same culture water body of a single culture tray the high light zone is connected to the low light zone in a diffusion-locked manner.

If the Lemnaceae are harvested after, e.g., 3 days each time by completely skimming off only the coverage in the high light zone, the Lemnaceae remaining in the low light zone can expand again into the high light zones through by further regrowth through spouting.

This immediately has two important effects. On the one hand, the relaxation of the population density in the low light zone provides an enormous growth stimulus and on the other hand, the population grows step by step from harvest to harvest from the low light zone to protein and mass maturity, automatically by expansion.

In a further advantageous embodiment, it is specified that the lighting (=supplied light as a culture parameter or control variable) is used in the zone of cyclic partial harvesting, i.e., where the cyclic partial harvesting takes place, so that the lighting used there is adapted to a biomass quantity to be achieved and to a biomass starch content to be achieved in terms of both the light quantity and the light quality, by regulating the light quantity wavelength-selectively.

With the knowledge that the optimal nutrient composition is a question of the lighting conditions in the respective tier of the tier culture system, it can be found that areas with the same lighting are also supplied with the same nutrient spectra.

In a further alternative embodiment, it is specified that said lighting is used in the zone that is positioned upstream of the cyclic and partial harvesting zone, so that the aquatic plants first expand through high light zones before they are again stimulated to maximum protein synthesis in a low light zone before harvesting. This can be specific for the protein synthesis of certain varieties.

In a further advantageous embodiment, it is specified that for achieving optimized, target-requirement-regulated protein and/or starch contents in the biomass, the control variable “supplied light” is determined by means of the control parameters “light quality” and “light quantity” in an in situ measurement of samples of the harvested biomass or from random samples of biomass taken from a harvesting zone, and thereafter, the light quality and light quantity can be adapted and controlled to the desired biomass quality using the control parameters determined in this way by the controller of the harvesting apparatus.

This comprises two effects, namely, the lighting with global radiation (sunlight) or a partial or complete lighting with light-emitting diodes. This exploits the fact that the shelving system decreases from top to bottom in terms of pure global radiation lighting and is illuminated additionally or alternatively with artificial lighting that is plant-physiological, i.e., adapted according to wavelength and energy density, if necessary at least when a minimum threshold for plant-physiological low light tolerance is reached.

Here it is important to consider that the physiological photosynthetic systems of the aquatic plants used, in particular Lemnaceae (duckweed) react to certain wavelengths, which are in particular in the range of approx. 350 nm and approx. 700 nm, and other specific wavelengths in between. The artificial light lighting must be adapted to this.

In a further advantageous embodiment, it is specified that the culture trays are each elongated trays, where harvesting zones are each arranged at least at one end of the culture trays, and that a lighting that can be controlled or regulated in terms of light quality and light quantity and that is supplied to the culture trays is oriented towards these harvesting zones or towards the middle of the length of the culture trays.

In a further advantageous embodiment, it is specified that in addition to controlling a light quality and a light quantity, feeding of the aquatic plants is done by controlling the addition of macronutrients nitrogen, phosphorus and potassium via a nutrient solution in such a way that the concentrations of the added macronutrients are adapted to the light quality and/or light quantity until the respectively desired optimized protein and/or starch values are achieved.

Furthermore, it is an advantageous embodiment that the ratio of ammonium nitrogen (NH₄⁺) added to the nutrient solution is adapted to nitrate nitrogen (NO₃⁻) added in such a way that the nitrate nitrogen content predominates over the ammonium nitrogen content and that the phosphorus/nitrogen ratio is adjusted between 1/20 and ⅕ respective to the aquatic plant variety used.

In a further advantageous embodiment, it is specified that the addition of the oligo-nutrient magnesium and/or sulphates is also adapted to the mode of operation described above. This makes sense because the intake of these nutrients is helpful, among other things, for an optimized photosynthesis efficiency.

The same naturally also applies to the trace elements, namely, that the additional addition of the trace elements zinc and/or copper and/or molybdenum and/or manganese and/or iron is adapted.

In a further advantageous embodiment, it is specified that the additional addition of CO₂ to the gas space of the culture facility is done and is regulated up to a concentration value of ≤5,000 ppm.

In a further advantageous embodiment it is specified that alternatively or in addition to the addition of carbon dioxide, carbonic acid is added in a degassing manner or directly into the culture water via the nutrient solution supply.

In a further advantageous embodiment, it is specified that the pH value of the nutrient solution and/or the culture water is buffered or adjusted by adding an aqueous calcium carbonate solution in such a way that a pH value in the culture water is adjusted between 5.5 and 8.0.

Furthermore, it is an advantageous embodiment that the culture system is operated at a temperature of the culture water between 20 and 30° C. Optimum growth is achieved at an optimum temperature of the culture water of 29° C. This temperature is preferably approached as the target variable. Lowering the temperature to approx. 20° C. (night lowering) during a dark phase is not detrimental to the biomass yield but offers potential savings for the total energy required for cultivation accordingly.

It is advantageously specified that Lemnaceae spp of the genus Spirodela-Polyrhiza, and/or Landolthia-Punctata, and/or Lemna Minor-L, and/or Lemna-Gibba, and/or Wolffilella-Hyalina, and/or Wolffia-Microscopica, and/or hybrids from at least two genera are used as culture plants.

The use of the method according to the application is suitable for all genera (species) of Lemnaceae: These are: Lemna, Spirodela, Wolffia, Wolfiella, Landolthia, and possible crosses between the genera.

For all these species applies that all amino acids are contained, but above all, that the important essential amino acids are represented in the mentioned duckweed.

The most important, i.e., essential, amino acids in terms of nutritional physiology include:
metheonine
threonine
valine
Leucine
I-leucine
phenylalanine
lysine
   In addition, for example, also glutamic acid, glycine and aspartic acid. These are all represented in the named species.

It is also of particular importance that there are connections between the uptake of nitrogen and the incident light quality and the light quantity. Since, as already mentioned, nitrogen is the decisive and physiologically limiting factor for protein synthesis, adequate lighting is required, essentially in relation to the photosynthetically effective wavelengths. Surprisingly, sufficient here still means low light conditions.

The low light tolerance of the Lemnaceae shows a high efficiency here with regard to the photosynthetic efficiency. This low light tolerance property can already be observed in the wild, where Lemnaceae (duckweed) propagate very well in areas that are still extremely shady.

Advantageously, it is specified that at least each individual culture tray is operated with only one single variety of Lemnaceae. This ensures that there is only a single growth gradient in the culture, because cultivation of mixed varieties leads to competing propagation, which would be disadvantageous for the overall yield.

In a further advantageous embodiment, it is specified that for the production of protein-maximized biomass and/or protein isolates, the culture method described is included in the protein isolate production process and adapted for in situ adaptation of the harvesting quantity of aquatic biomass to the protein isolate production process in such a way that both the nutrition of the aquatic culture plants and the operation of said additional lighting are adapted in such a way that predetermined amino acid spectra, i.e., amino acid distributions, are generated in the harvested biomass.

Furthermore, it is an advantageous embodiment that, in order to obtain defined, optimized amino acid spectra, the culture trays of definable areas of the culture system are each supplied with a constant light quality and a constant nutrient supply. The nitrogen supply should preferably also be adapted to this.

In a further advantageous embodiment, it is specified that a constant supply of nutrients to a definable area means a constant ratio of micronutrients and macronutrients. In detail, the absolute quantities, e.g., of the NH₄+/NO₃− ratio, can be changed, whereby the respective absolute quantities in the concentration of the other nutrients also change, such that the molar ratios of the nutrients to one another are again in the specified range. In order to suppress an unwanted algal co-population, the molar ratio of NH₄+/NO₃− can be adjusted to 1/9 and a total nitrogen concentration can be set to a target value of approx. 1.0+/−0.2 mmol/L. Furthermore, it is then also possible that, deviating from the specified target value, the molar ratio of NH₄+/NO₃− is switched from 1/9 to 2/8, at least temporarily over one or more days, with the same total nitrogen concentration as soon as an in situ analysis shows an increase in the calcium oxalate concentration in the harvested biomass and/or that the calcium oxalate concentration in the biomass should be lowered. It can be very advantageous here that this switching of the molar ratio of NH₄+/NO₃− is performed alternately from 1/9 to 2/8. This means over a period of one or more days at a time.

Furthermore, it is an advantageous embodiment that a constant light quality means a constant selection of wavelengths.

In a further advantageous embodiment, it is specified that the amino acid spectra are pre-analysed in relation to light quality and nutrient spectrum for each described area and are then regulated by keeping the respectively optimized light quality and nutrient spectra constant. However, in order to find this optimum, a temporary variation of the total quantity of light or of the integral over the entire spectrum PAR (photosynthetic active radiation) is first made, and the energy ratio E(440)/E(680) in mW/m² between the blue line at 440 nm and the red line at 680 nm is adjusted between 0.2 and 1.0 until the desired optimum is achieved in the biomass and the adjusted light quality and light quantity is further kept constant at the optimum.

Furthermore, it is an advantageous embodiment that, at least in the areas lighted with global radiation or with artificial light, during the active lighting periods, a temperature gradient is driven by heating or cooling, which, in terms of engineering control, aims for a constantly optimized culture and air temperature.

Furthermore, it is an advantageous embodiment that the relative humidity is at least constantly regulated by ventilation, heating and active or passive condensation.

In the last advantageous embodiment, it is specified that the CO₂ content is also included and controlled in the optimization of the amino acid spectra and the biomass yield.

With regard to an apparatus of the generic type, an automatically controlled culture facility for aquatic plants is proposed, wherein the aquatic plants are cultivated in a stacked culture tray system with an aquatic production area, wherein the aquatic plants are extracted by a cyclic and partial harvesting of the aquatic production area, wherein the aquatic plants grow back again on the aquatic production area until the next harvest. According to the invention, the culture facility (=apparatus) comprises that the culture trays of the culture tray system are provided with a nutrient injection system, wherein the nutrient injection system is quantitatively controllable via a control computer, that the culture is initially populated by seeding with aquatic plants along a growth sigmoid (=sigmoidal growth curve) to a coverage status of more than 50% above the previously determined variety-, genus-, and light-dependent marginal coverage, and that thereafter at cyclically recurring time intervals, which are designated as harvesting cycle times, a quantity of 5%-70% of the respective coverage is harvestable via a harvesting device, and that the harvesting cycle times are optimizable in a predetermined manner via modelling the growth process within a control computer with temperature, CO₂ concentration, light as culture parameters and enter a control of a harvesting apparatus, and that in the case of a change of one or more of these culture parameters within the culture facility, the respective time of the harvest and/or a respective harvesting amplitude are automatically re-adjustable.

In a further advantageous embodiment, it is specified that the sigmoidal growth curve for the aquatic plant varieties used is stored in an adaptive data field, from which the sigmoid determined on this basis can then modellable as growth curve in the control computer by running the harvesting cycles or the coverage status on a precisely predetermined sawtooth curve, and that, from the modelling thus automatically triggered, the values for the harvesting times along the upper peak values of the sawtooth curve can be automatically adjusted in situ and enter the control of the harvesting apparatus.

In a further advantageous embodiment, it is specified that an in situ detection of the components of the biomass harvested that is performable in the culture trays via sensors enables the determination of accumulated heavy metals and accumulated calcium oxalate in order to minimize these heavy metal and calcium oxalate concentration values in the biomass, and whereupon the harvesting cycle times are adjustable via the modelling in such a way that stable short harvesting cycles of 0.5 to 5 days result.

Furthermore, it is an advantageous embodiment that the harvesting cycle times and, thus, the residence times are optimally shortenable so that the accumulation time for heavy metals and calcium oxalate is significantly reducible with a simultaneously high protein content.

In the last advantageous embodiment, it is specified that the culture facility is provided with an integrated browser.

With regard to a computer program product for controlling an automatic culture apparatus according to any of claims 27 to 31 that is operated according to a method according to any of claims 1 to 26, the core of the invention is that the computer program product is designed as a volatile control program, where the characteristic data of the respective sigmoidal growth parameters related to the plant genera and or varieties respectively used are stored in an updatable program tool.

To this end, it is further embodied that the computer program product contains a remote control and/or remote maintenance tool that interacts with the control system and the browser of the culture apparatus.

An exemplary embodiment of the invention is specified in the drawing and described in more detail below.

It is shown in:

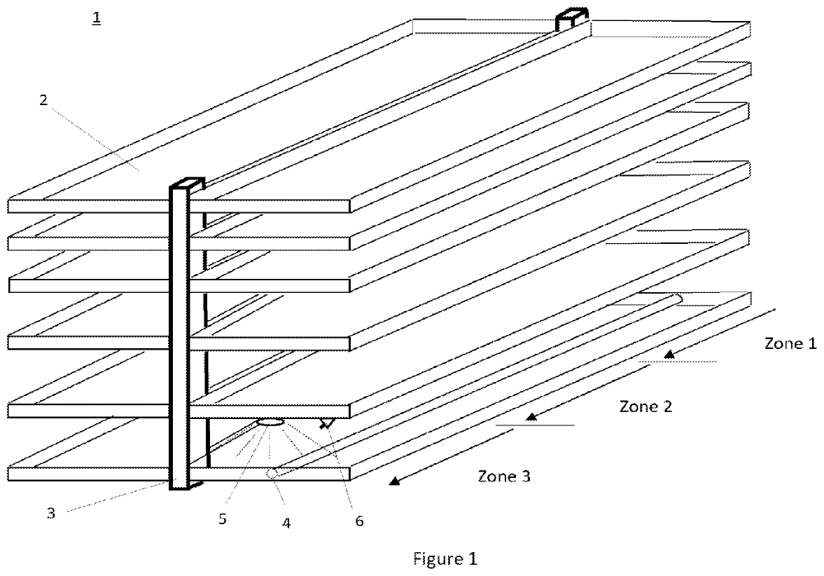

FIG. 1: a perspective view of a stacked culture tray arrangement,

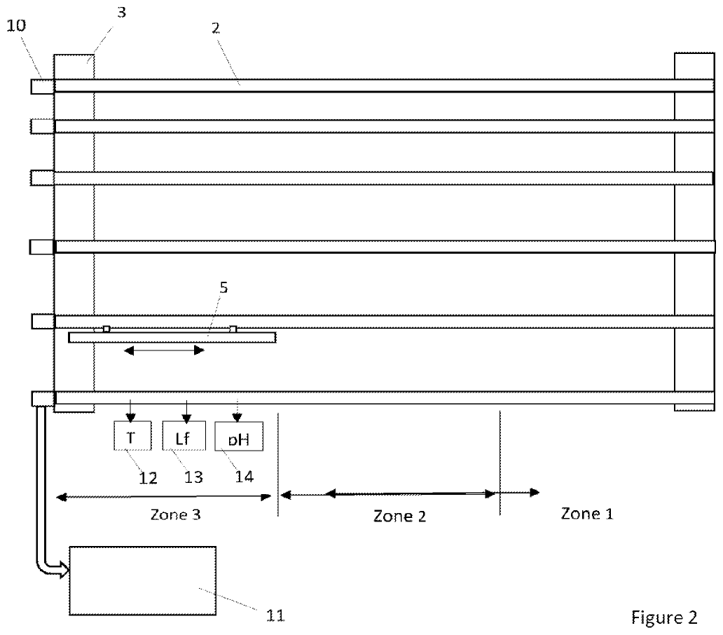

FIG. 2 a schematic side view of a stacked tray arrangement, and

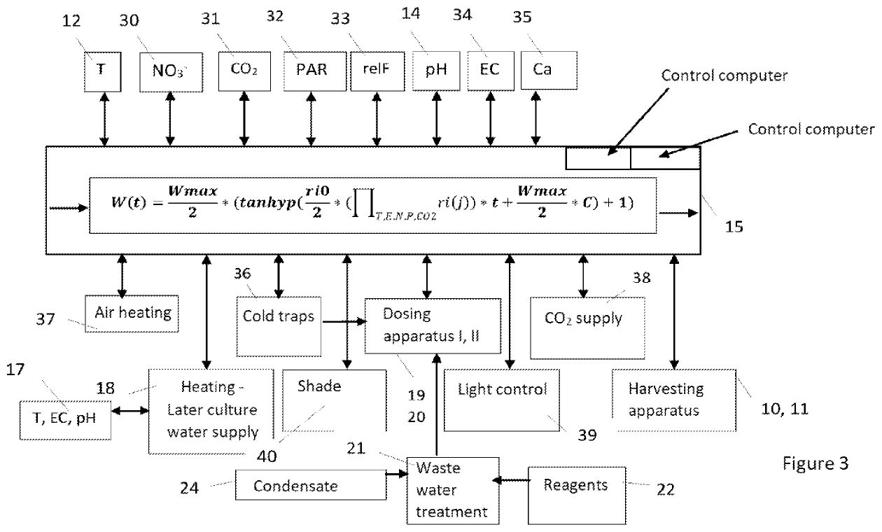

FIG. 3: a controller of the culture facility

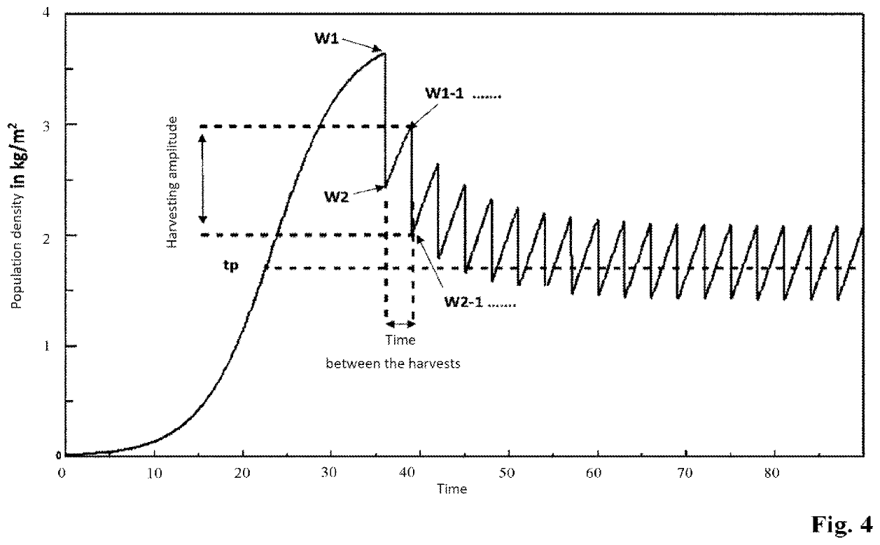

FIG. 4: a growth sigmoid with harvesting times and harvesting amplitudes

FIG. 1 shows a perspective view of the aquatic culture tray arrangement 1 with stacked culture trays 2, wherein the culture trays 2 have a corresponding height distance from one another, so that the cultures can also be worked on if necessary, and, in addition, that correspondingly reduced light from the global radiation can still incident. The culture trays 2 are filled with nutrient solution (culture water) and, for example, occupied by Lemnaceae (duckweed). The entire arrangement 1 is in turn arranged in a greenhouse as an indoor culture system.

As an example for all culture trays 2, it is shown at the lower tray that the culture trays 2 are additionally provided with auxiliary lighting 5, which can be adjusted in terms of both the light quality (wavelengths, wavelength mixtures) and the light quantity. The other culture trays 2 also have the auxiliary lighting 5 (not shown). This auxiliary lighting 5 is configured to supply light to the culture trays 2 and, thus, to the aquatic production area. This auxiliary lighting 5 is controlled by a controller. Preferably only the so-called maturation zone (zone 3), i.e., the culture area (=production area) marked in FIGS. 1 and 2 of each tray 2 is illuminated with the auxiliary lighting 5. From this, it is also harvested. The other zones (zone 1 and zone 2 of FIGS. 1 and 2) are pronounced low light zones in which the aquatic plants mentioned are stimulated for sprouting (vegetative propagation). The partial harvest is preferably also performed on the respective maturation zone of each tray.

According to the invention, the illuminated zone does not have to extend over the entire length of the culture tray 2, but the culture tray 2 as such is imaginarily divided into zones, which are connected to or in fluid communication with one another in terms of culture water.

It is also shown that the culture trays 2 can be heated directly, for example, by a hose system 4 carrying hot water, via which optionally at least part of the nutrient solution for the cultures can also be supplied, for example, through diffusion openings. The culture parameter temperature can thus be controlled by means of the controller.

Additionally or optionally, nutrient solution sprayers 6 are arranged above the respective trays 2 in such a way that at least part of the nutrient solution and/or conditioning agents, such as sanitizing substances or algicides, can be sprayed on.

FIG. 2 shows a side view of the schematic representation of the culture tray arrangement 1. In this representation, the harvesting skimmers 10 for skimming off the duckweed are respectively arranged at one end of the culture trays 2. However, it can also be skimmed off, i.e., harvested, at both opposite sides.

In principle, only partial harvesting of the culture trays 2 is provided according to the state of the art mentioned at the outset. For example, a third of the length of the culture tray 2 is skimmed off in regular cycles. Partial harvests can be performed daily or in a 2-, 3- or multi-day rhythm.

Since a culture facility consists of a large number of such tier arrangements shown in FIGS. 1 and 2 placed side by side, which are installed in a closed greenhouse, the tier systems can also be harvested at different times, so that, for example, with a 3-day partial harvesting rhythm, there are always sections of racks that are harvested, another one on the following day, and again another one on the third day.

In relation to the respective culture, the 3-day partial harvest rhythm is always maintained, but the entire system still produces harvested biomass every day.

FIG. 2 clearly shows the placement of additional lighting by means of auxiliary lighting 5 according to the invention, for example, light-emitting diode arrangements, which can be controlled in terms of wavelength and intensity. This is repeated in every culture tray 2.

As can also be seen here, the entire elongated culture tray 2 is divided into three zones. Zone 1 is the rearmost zone on the right edge of the drawing. Zone 2 is the middle zone. Zone 3 is the zone directly in front of harvesting skimmer 10.

Zone 3 is harvested, e.g., with a pusher, not shown here, which pushes the duckweed to the skimmer 10, which then allows the biomass to flow downwards. As an alternative to the pusher, a so-called air broom can also be employed, which pushes the duckweed out over the skimming edge.

In this first exemplary embodiment, the light-emitting diode arrangement 5 is placed in the last zone 3, so that the duckweed in this zone is almost directly in front of the harvest and in front of an optionally controlled lighting with additional light.

For this, one must consider the following.

If zone 3 is harvested by a pusher and subsequent skimming, the duckweed culture expands from zone 2 and zone 1 into the skimmed and, thus, emptied zone 3, since the pusher creates a suction in the pushing direction, which pulls the entire culture into the harvested zone 3. Thus, the population density relaxes immediately over the entire length of the culture tray 2.

This has the physiological effect that the duckweed culture is thus significantly stimulated by thinning out of the population density for post-population. Thus, the culture is not only partially harvested, but its population density is relaxed to such an extent that the population rate remains in the maximum gradient of the growth sigmoid and, thus, regrows optimally.

When zone 3 is illuminated according to FIG. 2, the duckweed receives a final increased quantity of light in the last section after its population movement along the entire length of the culture tray.

Since the cultivation and the final protein optimization depend on the species, i.e., on the duckweed genus and variety, it is further embodied according to the invention that the zone illuminated with the additional lighting 5 does not necessarily have to be zone 3. Rather, it is to be expected that certain species then operate at an optimum level of final protein synthesis if they are first exposed to the additional lighting 5, e.g., in zone 2, but then go through a low light phase again before harvesting in zone 3.

In this example, the additional lighting 5 would have to be placed in or moved to the middle, i.e., zone 2.

It is also possible to place the additional lighting 5 in zone 1.

A sensory measurement of temperature and/or conductivity and/or pH value takes place in particular, but not exclusively, in zone 3 shown.

In the case that both ends of the elongated tray are harvested, measurements can also be taken at both ends or both ends can be illuminated in the manner described above.

With such an embodiment, the above-mentioned alternative lighting conditions could be realized by having the illuminated zone in the middle and the harvesting zones, again in low light, at the two opposite zones.

The harvested duckweed is extremely easy to dry, for example, by using a warm air dryer with a fleece. Since adult duckweed have permanently open stomata, the duckweed dries extremely quickly, even if the drying is performed in a humid greenhouse with a warm air flow of only 40° C. The drying time is then only 1 to 1.5 hours.

FIG. 3 shows the controller 15 and control logic of the facility 1.

The sensors for temperature 12, for conductivity 13 and for pH value 14, which are connected directly to the culture water on the respective culture trays 2, are read into the controller 15 as sensor values in order to be able to monitor the status of the nutrient solutions.

The harvesting collector 11 is also controlled or controlled with feedback. Furthermore, a photo sensor for measuring the PAR light intensity can be provided at each tray 2. PAR designates the wavelengths relevant for photosynthesis.

Samples from the harvesting collector 11 can also be taken automatically in order to perform a nitrogen test and, thus, a rapid protein test. This is done by determining the bound nitrogen in the biomass. The crude protein content results from a conversion by a factor of 6.25. Furthermore, the control device consequently controls the additional lighting 5 in terms of light quality (wavelength) and light quantity.

The culture tray is heated directly by a warm water line 4 running through the culture tray 2. This is also temperature-controlled.

Furthermore, from the totality of the data, the control apparatus 15 also controls the waste water treatment, which is used at least as a source of nitrogen, phosphorus, and potassium.

Here, the quantity of condensate that has dripped off in the greenhouse and in system 1 is collected and returned through a controllable condensate return 24.

This is used twice. Firstly, when providing a zero quantity of water for mixing with the waste water, via the waste water treatment 21, and, secondly, for the final adjustment of a balanced nutrient solution by adding a zero quantity of water, which in this context should be referred to as a water lever, which adjusts the final concentration ratio in the nutrient solution.

The waste water supply, for example, liquid manure, fermentation residues, etc., is controlled via the controller 15. Furthermore, the addition of reagents 22 for precipitation and/or sanitization of the waste water 23 in the waste water treatment 21 is controlled.

Finally, a dosing meter 19 is controlled for the controlled addition of trace elements, and a dosing meter 20 is used to supply the nutrient solution from the waste water treatment regarding nitrogen, phosphorus, and potassium.

Both streams of material from the two dosing meters are supplied to a mixer, which creates the final nutrient solution for the aquatic culture trays and finally controls this via temperature and/or conductivity and/or pH value. The mixer is also controlled via the controller 15 and the culture water is pumped to the culture trays.

The quantity supplied should generally replace the evaporated quantity of culture water.

Daily replenishment of the nutrient solution is optimal.

This can be distributed either through lines laid in the trays or through the hot water line with diffusion openings. Another advantageous option is to spray the aquatic cultures, here duckweed, with nutrient solution from above using the nutrient solution sprayers 6 arranged along the trays 2.

It is also advantageous if the nutrient solution is adjusted in such a way that the nutrients contained in the quantity of evaporation corresponds to the average nutrient uptake in the same time period. This avoids the accumulation of nutrients in the culture trays 2.

If this is controlled via conductivity and pH, this can be done in a simple manner.

The control of the lighting system 5 can be coupled with the nutrient supply, in particular the nitrogen, via an algorithm stored in the controller 15 so that the local addition of nitrogen and other macro-, oligo- and micro-nutrients in the respective zone of the tray 2 is adapted to the achieved energy value of the lighting.

For this purpose, light sensors can be provided in the so-called PAR region, which measure the effective lighting.

Furthermore, FIG. 3 once again gives an overview of all the procedural considerations of the control, sensors and individual elements of the culture facility according to the invention. The controller 15 of the culture facility 1 comprises one or more control computers. Several control computers and also several harvesting apparatuses 11, 12 can then be necessary if the greenhouse is divided into respective autonomous, mutually sealed compartments, in which the respective culture conditions differ from one another, for example, to produce different biomass qualities and/or different plant species.

The air heating 37 and the dosing apparatuses 19 and 20 for the fertilizer solutions, the CO₂ supply 38 as well as the harvesting apparatus are controlled via the controller 15, which is done in the manner described above and according to the specified algorithm. The later culture water supply 18 (also culture water mixer) also contains sensors for detecting the temperature, the conductivity and the pH value of the culture water supplied later, in order to adapt these to the procedural modelling measures. Sensor(s) 30 for determining the nitrate concentration is (are) arranged in the culture water of the culture trays 2. CO₂ sensor(s) 31 for determining the CO₂ concentrations is (are) also placed in the area of the culture tray(s) 2, likewise as sensor(s) 32 for measuring the photonic energy in the PAR region. Furthermore, the relative humidity is determined via corresponding sensor(s) 33.

The pH value in the culture water (nutrient solution) is also determined via sensor(s) 14 and the electrical conductivity is also determined via corresponding sensor(s) 34. Finally, camera(s) is (are) preferably used, which can be aimed at the surfaces of the Lemnaceae cultures and make it possible to determine the growth status of the culture via pattern recognition.

All sensor values are supplied to the controller 15 in real time and used in the algorithm in the manner described above, wherein the values for relative air humidity and the pH values are also consulted as evaluation variables for the biological state of the cultures. Experience has shown that the conductivity should be at least 500-2,200 μSiemens and the pH should be between 5.8 and 7.5. The air heating 37, the cold traps 36, the dosing apparatuses 19 and 20, the CO₂ supply as well as the heating of the later culture water supply 18, which corresponds to the dosing apparatuses 19 and 20 for fertilizer supply, are then controlled via the controller. The dosing apparatuses 19 and 20 dispense the necessary fertilizer as required, wherein the later culture water supply 18 also corresponds to the dosing apparatuses 19, 20 in order to precisely adjust the pH value and the conductivity in the fertilized and water-balanced fill level of the culture trays 2. For this purpose, the dosing apparatuses 19 and 20 are fed by a waste water treatment 21 and/or by the return of the condensate 24 from the cold traps 36, to which the individual fertilizer components (reagents) 22 are then supplied. The light control 39 regulates the desired lighting values of the maturation zones illuminated with LEDs.

Finally, the resulting optimal harvesting intervals (harvesting cycles) and the optimal harvesting quantities (harvesting amplitudes) are determined via the control computer of the controller 15, and then the corresponding harvesting quantities from the maturation zone are skimmed off by appropriate control of the harvesting apparatuses 10, 11. The remaining culture in the culture tray 2 relaxes in the culture density, so that an optimal offspring of the culture arises as symmetrically as possible around the point of the maximum gradient of the sigmoidal growth curve, which is skimmed off again during the next harvest (etc.).

The shade 40 can be used to shield excessive global radiation components above the culture trays or culture tray shelves, for example, in summer. Corresponding critical values, which control a shade, come from the temperature measurement (risk of overheating in the upper culture tray 2 in the shelf) and/or via the light sensors if the global radiation exposure is too high.

The actuation of the shade 40 also has a further function if, for example, in the case of very strong night-time cooling outside the greenhouse, excessive heat loss upwards at night is to be avoided by closing the shade 40.

### ALTERNATIVE EMBODIMENTS

As an alternative to cultivating the aquatic plants in a stacked culture tray system, cultivation in a monolayer, i.e., one level of culture trays 2, or in a CO₂ gassed film tunnel is also possible.

A further alternative is to perform the method in a closed room, also without the admixture of global radiation, but with the exclusive employment of artificial light.

Furthermore, the LED lighting system 5 can also be operated in the pulsed control mode. Since LEDs are present as purely electronic semiconductor components, electrical energy can be saved in the light-pause times by timed application of electrical energy.

A further addition to the operating method is to also integrate the preculture already mentioned in the state of the art mentioned at the outset.

This means that, prior to the addition of trace elements by dosimeter 1, the treated nutrient water is passed through an aquatic preculture with hyperaccumulators, such as Eichhornia crassipes and/or Pistia stratiotis and/or Nasturtium officinales (watercress) and/or alligator weed and/or comfrey and possibly any aquatic or marsh plants, or through hydroponic cultures of any kind for the depletion of nutrients and, above all, for the hyperaccumulation of heavy metals before the waste water is supplied to Lemnaceae cultures.

In this way, other pollutants, such as heavy metals or nutrient water that is still too highly concentrated can be depleted from the preculture, especially, small concentrations that are difficult to clean can be biogenically filtered out in this way.

The Lemnaceae are approved according to the HACCP method mentioned in full above and have been included in the positive list for individual animal feeds of the DLG (as of April 2017). Furthermore, the use of the Lemnaceae (duckweed) produced in this way in the field of human nutrition, for example, as novel food, is desired and advantageous.

With a view to the high protein content of up to 40% and more, it is also suitable for the production of high-end protein isolates due to its high-quality amino acid spectrum.

In particular, the system 1 can also be used in fish farming, where the fish manure is treated as waste water in the manner mentioned above and supplied to the Lemnaceae as a nutrient solution, which in turn is used as high-quality fish feed after sanitization.

Here, too, the said cascade benefit can be implemented.

Furthermore, it is possible to convert the vegetable proteins of the duckweed into animal proteins by feeding them to insects.

In the case of elongate culture trays 2, the zones can also be embodied as a kind of water staircase.

This means that the sub-cultures in the zones flush the duckweed from one zone to the next zone like a shift register after a corresponding dwell time. In order for this to take place in a coordinated manner, the last, final harvesting zone 3 must of course first be emptied by harvesting before the other zones are supplied later. Zones 1 and 2 must never be completely emptied, but the seeding biomass must remain for the next cycle.

At least to the preceding zone is now so much culture water supplied that the cultures in the following zone are flushed over the respective skimmer edge. The skimmer edges between Zone 1 and Zone 2 are higher than between Zone 2 and Zone 3, so that there is no backflow since flooding should be sone step by step from Zone 1 to Zone 2 and then to Zone 3. Duckweed is extremely easy to wash over skimmer edges because it is extremely flowable. At the end of Zone 3, the final harvest takes place.

FIG. 4 shows the growth sigmoid which is modelled or calculated on the basis of the previously determined plant-specific parameters mentioned above and is obtained for the culture plant. The growth sigmoid represents the population density of the culture plant as a function of time (in days). In practice, the modelled growth sigmoid reaches an approximation accuracy of 99.4% to the real growth sigmoid of the aquatic culture in the aquatic culture facility. It is assumed here that the control parameters that are used in the modelling were also achieved in reality with a correspondingly accurate level of accuracy in the control target. If, for example, a deviation is determined, then either the control targets of the control parameters for the culture parameters temperature and/or light and/or CO₂ and/or nutrition (fertilization) are adaptively readjusted as described above, or a new modelling is triggered, which takes this deviation into account, and new optimal harvesting times and new optimal harvesting amplitudes are calculated therefrom and updated accordingly in the controller of the culture facility. The growth sigmoid shows an increase in the aquatic culture from the start (seeding) of the culture on each culture tray 2 until a population density is reached that is significantly (approx. 30%) above half the limit density tp. This is where the harvest starting point W1 is located. The quantity removed here reduces the population density to point W2. The difference from W1-W2 corresponds to the harvesting quantity or harvesting amplitude. This is preferably limited to the quantity corresponding, for example, to ⅓ of the area of the illuminated zone 3 (see, for example, FIGS. 1 and 2). However, it can also correspond to the entire length of the area of zone 3. Thus, if there is a change, the modelling will determine the next possible optimal harvesting time.

After the harvest or the partial harvest, the culture grows again with the same growth parameters of the original growth sigmoid from the population of the population density W2 that was decimated by the harvest until it reaches a further point W1-1, etc. What is also visible here is the effect that if the point W1 is approached very high in the population density, the sawtooth curve formed by the repeated harvests undergoes a downward relaxation until the sawtooth curve nestles symmetrically around the point tp of the growth sigmoid. This is the point of maximum growth gradient of the growth sigmoid of the aquatic culture. With the same area of partial harvesting, the extracted harvesting quantity decreases slightly (it can be seen that the harvest amplitudes are slightly smaller with each subsequent harvest) until the harvesting quantity (=harvesting amplitude), harvesting times, are in offspring equilibrium of the population of the aquatic culture. After that, harvesting amplitudes and harvesting times are the same. The invention shows here most clearly the implementation of population dynamic modelling in order to ultimately achieve maximum harvesting yields.

What is important here is the consistent technical integration of the controller of the aquatic culture facility, as described above.

### REFERENCE NUMERALS

1 culture tray tier system
2 culture tray
3 pillar
4 hose system, heating
5 auxiliary lighting, LED lighting system, additional lighting, if necessary longitudinally displaceable along the zones
6 nutrient solution sprayer
Zone 1 culture tray section
Zone 2 culture tray section
Zone 3 culture tray section
10 skimmer, harvesting skimmer
11 harvesting collector
12 temperature sensor at culture trays
13 conductivity sensor at culture trays
14 pH sensor at culture trays
15 controller
16 temperature control
17 sensor unit (T, Lf, pH) at culture water mixer
18 later culture water supply, culture water mixer
19 dosing apparatus I, NPK, trace elements, oligo-nutrients
20 dosing apparatus II
21 waste water treatment
22 fertilizer components, reagents
23 sewage, Nutrient Water
24 condensate return
30 nitrate sensor (NO3−)
31 CO₂ sensors
32 light sensor, sensitive to photosynthesis-relevant radiation PAR
33 relative humidity sensor
34 conductivity sensor EC
35 camera
36 cold traps
37 air heating
38 CO₂ supply
39 light control
shade
W1 population density at the start of the first partial harvest
W2 population density after the first partial harvest
W1-1 population density at the start of the second harvest
W1-2 population density after the second harvest

1.-33. (canceled)

34. A method for operating a culture facility for aquatic plants comprising: cultivating the aquatic plants in a stacked culture tray system having an aquatic production area, thereby generating a culture of the aquatic plants; extracting the aquatic plants by a cyclic and partial harvesting of the aquatic production area; and re-growing the aquatic plants on the aquatic production area until the following harvest, wherein
the culture is initially populated by seeding with aquatic plants along a sigmoidal growth curve (W) to a coverage status of more than 50% above a previously determined variety- and light-dependent marginal coverage (Wmax),
after populating to more than 50% marginal coverage (Wmax) at cyclically recurring time intervals (Δt), which are designated as harvesting cycle times, a quantity of 5%-70% of a respective coverage is harvested,
harvesting cycle times are optimized in a predetermined manner via modelling a growth process with a temperature, a carbon dioxide concentration, and/or a light supplied to the aquatic plants as culture parameters and fed in a controller of a harvesting apparatus or a harvesting method as a respective control variable for a determination of an optimal time for triggering a harvest, and
wherein, in the case of a change of one or more of these culture parameters within the culture facility, a respective time of the harvest and/or a respective harvesting amplitude are automatically readjusted.

35. The method according to claim 34, wherein the sigmoidal growth curve is determined for aquatic plant varieties used prior to the operation of the culture facility and is stored in an adaptive data field in the controller, wherein the sigmoidal growth curve is modelled from the data field, wherein the harvesting cycle times or the coverage status correspond to a predetermined sawtooth curve progression, wherein values for the harvesting times from the modelling are automatically adapted in situ along the upper peak values of the sawtooth curve progression, and wherein the adapted values are supplied to the controller of the harvesting apparatus.

36. The method according to claim 34, wherein if the temperature, the light, and/or the carbon dioxide concentration as the control variable in the culture facility fall below a correspondingly adjustable threshold value or rises above a correspondingly adjustable threshold value over a pre-definable and adjustable time interval, an optimal harvesting time is automatically re-determined on the basis of the changing control variable.

37. The method according to any of claim 34, wherein the sigmoidal growth curve is generated on the basis of a growth equation for limited growth, wherein in the growth equation a growth factor is formed in the exponent of a natural exponential function as the product of a light-dependent, a temperature-dependent, a carbon dioxide concentration-dependent and a nutrient-dependent coefficient, multiplied by a base growth rate, wherein the result from this growth equation is stored then in the controller of the harvesting amplitude extracted for each harvest, wherein the respective optimum times for triggering the harvest are determined via a control equation of the controller on the basis of this stored result.

38. The method according to claim 34, wherein an in situ detection of components of a biomass harvested by the cyclic and partial harvesting of the aquatic production area enables a determination of accumulated heavy metals and accumulated calcium oxalate in order to minimize heavy metal and calcium oxalate concentration values in a biomass to be harvested, whereupon the harvesting cycle times are adjusted via the modelling in such a way that temporally stable short harvesting cycles of 0.5 to 5 days result.

39. The method according to claim 34, wherein the harvesting cycle times and residence times of the aquatic plants on the aquatic production area are optimally shortened, so that an accumulation time for heavy metals and calcium oxalate is significantly reduced with a simultaneously high protein content of a biomass to be harvested.

40. The method according to claim 34, wherein a nutrient solution supplied into the culture facility is balanced in such a way that supplied quantities of nutrients are adjusted to correspond to a respective consumption in the culture system during the harvesting cycle times.

41. The method according to claim 40, wherein starting from an adjusted nitrogen level, remaining macro elements phosphorus, potassium and oligo-element magnesium are adjusted in a molar ratio of:
3:1≤N/P≤10:1
2:1≤N/K≤4:1
10:1≥N/MG≥5:1
where N is nitrogen, P is phosphorus, K is potassium and Mg is magnesium.

42. The method according to claim 41, wherein to suppress unwanted algal co-population, molar ratio of NH₄⁺/NO₃⁻ in the nutrient solution is adjusted to 1:9 and a total nitrogen concentration is adjusted to a target value of 1.0 t 0.2 mmol/L.

43. The method according to claim 41, wherein adjusting the nutrient ratios suppresses an unwanted algal co-population, and is monitored in situ by means of automatic and adaptive image recognition of camera images of at least one representative culture surface.

44. The method according to claim 34, wherein protein content in the culture is adjusted by taking samples and adapting the protein content thereafter as coefficients of a control equation in the controller.

45. The method according to claim 34, wherein a light supply in a zone of cyclic and partial harvesting is used in such a way that the light supply in the cyclic and partial harvesting zone is adapted to a biomass quantity to be achieved and to a biomass protein content to be achieved in terms of both the light quantity and the light quality, by regulating the light quantity wavelength-selectively.

46. The method according to claim 34, wherein a light supply is used in a zone that is positioned upstream of the cyclic and partial harvesting zone so that the aquatic plants first expand through high light zones before the aquatic plants are stimulated to maximum protein synthesis in a low light zone before harvesting.

47. The method according to claim 34, wherein a ratio of ammonium nitrogen added to a nutrient solution is adapted to nitrate nitrogen added in such a way that nitrate nitrogen content predominates over ammonium nitrogen content, and that a phosphorus/nitrogen ratio is adjusted between 1:20 and 1:5.

48. The method according to claim 34, wherein the aquatic plants comprise Lemnaceae spp. of the genus Lemna, Spirodela polyrhiza, Landoltia punctata, Lemna minor L., Lemna gibba, Wolffilella hyalina, Wolffia microscopica, and combinations thereof, are used as culture plants.

49. An automatically controlled culture facility for aquatic plants, wherein the aquatic plants are able to be cultivated in a stacked culture tray system having an aquatic production area, extracted by a cyclic and partial harvesting of the aquatic production area, and re-grown on the aquatic production area until the next harvest, said controlled culture facility comprising:
culture trays in the culture tray system provided with a nutrient injection system, wherein the nutrient injection system is quantitatively controllable via a control computer, and wherein the culture is initially populated by seeding with aquatic plants along a sigmoidal growth curve to a coverage status (W1) of more than 50% above a previously determined variety, genus, and light-dependent marginal coverage (Wmax),
a harvesting device, wherein after populating to more than 50% marginal coverage at cyclically recurring time intervals, which are designated as harvesting cycle times, a quantity of 5%-70% of a respective coverage is harvestable via the harvesting device,
wherein the harvesting cycle times are optimizable in a predetermined manner via modelling with the control computer using one or more culture parameters comprising temperature, carbon dioxide concentration, and light supplied to the aquatic plants, wherein, in case of a change of one or more of the culture parameters, a respective time of harvest and/or harvesting amplitude are automatically re-adjustable.

50. The automatically controlled culture facility according to claim 49, wherein the sigmoidal growth curve is stored in an adaptive data field in the control computer, wherein the sigmoidal growth curve is able to be modelled from the data field, wherein the harvesting cycle times or coverage status correspond to a predetermined sawtooth curve progression, wherein values for the harvesting times from the modelling are automatically adaptable in situ along upper peak values of the sawtooth curve progression.

51. The automatically controlled culture facility according to claim 49, wherein an in situ detection of components of a biomass harvested that is performable in the culture trays via sensors enables a determination of accumulated heavy metals and accumulated calcium oxalate.

52. The automatically controlled culture facility according to claim 49, wherein the harvesting cycle times and residence times of the aquatic plants in the aquatic production area are optimally shortenable, so that an accumulation time for heavy metals and calcium oxalate is significantly reducible with a simultaneously high generated protein content.

53. A computer program product for controlling an automatic culture facility according to claim 49, wherein the computer program product is designed as a volatile control program, where the characteristic data of the respective sigmoidal growth parameters related to the plant genera and or varieties respectively used are stored in an up-to-date program tool.
